(19) United States
(12) Patent Application Publication
(10) Pub. No.: US 2020/0111075 A1
(43) Pub. Date: Apr. 9, 2020

(54) Method, System, and Computer Program Product for Automatically Combining a Plurality of Separate Orders

(71) Applicant: Visa International Service Association, San Francisco, CA (US)

(72) Inventor: Ankush Singhal, Dublin, CA (US)

(21) Appl. No.: 16/152,656

(22) Filed: Oct. 5, 2018

(51) Int. Cl. G06Q 20/22; G06F 17/30; G06Q 20/40

(52) U.S. Cl. CPC G06Q 20/29; G06K 7/1413; G06Q 20/40; G06F 17/30879

(57) ABSTRACT

A computer-implemented method for combining a plurality of separate orders into a single transaction includes: receiving a request from a first user device identifying a plurality of users; in response to receiving the request, generating a unique identifier for each user of the plurality of users; receiving a plurality of order requests within a time period from a plurality of computing devices associated with at least a subset of users of the plurality of users, each order request of the plurality of order requests identifying the unique identifier for a respective user; determining that the time period has expired; and in response to determining that the time period has expired, generating an authorization request for a total transaction value of the plurality of order requests. A system and computer program product for combining a plurality of separate orders into a single transaction is also disclosed.

### BACKGROUND OF THE INVENTION

### Field of the Invention

This invention relates to a method, system, and computer program product for automatically combining a plurality of separate orders and, in a non-limiting embodiment, combining the plurality of separate orders into a single transaction.

### Description of Related Art

A group order is an order in which each user of a group includes their customized order with the customized orders of the other users of the group in single payment transaction, and a single payer pays for the entire group's order. Using existing methods, placing a group order requires a cumbersome process. This cumbersome process is also required in existing remote ordering scenarios in which the order is placed remotely and subsequently picked-up at the merchant location or delivered to a specified location.

In existing methods, the payer or other designated user is required to manually collect the customized order of each user in the group and place a single transaction with the merchant that covers the order of the entire group. In this way, the payer collects the user orders and then enters the user orders into the format required for submission of the single group order to the merchant.

Therefore, it would be desirable to develop a system and method that allows a group order to be placed more efficiently, while still allowing each user in the group to customize their part of the order based on their individual tastes.

### SUMMARY OF THE INVENTION

Accordingly, and generally, provided is an improved method, system, and computer program product for combining a plurality of separate orders into a single transaction.

According to a non-limiting embodiment or aspect, provided is a computer-implemented method for combining a plurality of separate orders into a single transaction including: receiving, with at least one processor, a request from a first user device identifying a plurality of users; in response to receiving the request, generating, with at least one processor, a unique identifier for each user of the plurality of users; receiving, with at least one processor, a plurality of order requests within a time period from a plurality of computing devices associated with at least a subset of users of the plurality of users, each order request of the plurality of order requests identifying the unique identifier for a respective user; determining, with at least one processor, that the time period has expired; and in response to determining that the time period has expired, generating, with at least one processor, an authorization request for a total transaction value of the plurality of order requests.

In one non-limiting embodiment or aspect, the unique identifier may include an identifier embedded link. The unique identifier may be embedded in a barcode. The unique identifier may expire in response to the user associated with the unique identifier using the unique identifier to place an order request. In response to generating each unique identifier, the processor may communicate each respective unique identifier to a computing device associated with an associated user of the plurality of users. The computing device may include at least one of the following: a smartphone, a laptop, a tablet computer, a desktop computer, an in-store kiosk, or any combination thereof. The request may include limit data including a maximum total transaction value and/or a maximum value per order request. The time period may expire after a predetermined duration or at a predetermined time. The time period may expire in response to receiving an order request from each user of the plurality of users. The time period may expire in response to not receiving a further order request for a predetermined time period.

According to a non-limiting embodiment or aspect, provided is a system for combining a plurality of separate orders into a single transaction including at least one server computer including at least one processor, the at least one server computer programmed or configured to: receive a request from a first user device identifying a plurality of users; in response to receiving the request, generate a unique identifier for each user of the plurality of users; receive a plurality of order requests within a time period from a plurality of computing devices associated with at least a subset of users of the plurality of users, each order request of the plurality of order requests identifying the unique identifier for a respective user; determine that the time period has expired; and in response to determining that the time period has expired, generate an authorization request for a total transaction value of the plurality of order requests.

In one non-limiting embodiment or aspect, the unique identifier may include an identifier embedded in a link. The unique identifier may be embedded in a barcode. The unique identifier may expire in response to the user associated with the unique identifier using the unique identifier to place an order request. The at least one server computer may be further programmed or configured to: in response to generating each unique identifier, communicate each respective unique identifier to a computing device associated with an associated user of the plurality of users. The computing device may include at least one of the following: a smartphone, a laptop, a tablet computer, a desktop computer, an in-store kiosk, or any combination thereof. The request may include limit data comprising a maximum total transaction value and/or a maximum value per order request. The time period may expire after a predetermined duration or at a predetermined time. The time period may expire in response to receiving an order request from each user of the plurality of users.

According to a non-limiting embodiment or aspect, provided is a computer program product for combining a plurality of separate orders into a single transaction including at least one non-transitory computer-readable medium including program instructions that, when executed by at least one processor, cause the at least one processor to: receive a request from a first user device identifying a plurality of users; in response to receiving the request, generate a unique identifier for each user of the plurality of users; receive a plurality of order requests within a time period from a plurality of computing devices associated with at least a subset of users of the plurality of users, each order request of the plurality of order requests identifying the unique identifier for a respective user; determine that the time period has expired; and in response to determining that the time period has expired, generate an authorization request for a total transaction value of the plurality of order requests.

Further embodiments or aspects are set forth in the following numbered clauses:

Clause 1: A computer-implemented method for combining a plurality of separate orders into a single transaction comprising: receiving, with at least one processor, a request from a first user device identifying a plurality of users; in response to receiving the request, generating, with at least one processor, a unique identifier for each user of the plurality of users; receiving, with at least one processor, a plurality of order requests within a time period from a plurality of computing devices associated with at least a subset of users of the plurality of users, each order request of the plurality of order requests identifying the unique identifier for a respective user; determining, with at least one processor, that the time period has expired; and in response to determining that the time period has expired, generating, with at least one processor, an authorization request for a total transaction value of the plurality of order requests.

Clause 2: The method of clause 1, wherein the unique identifier comprises an identifier embedded in a link.

Clause 3: The method of clause 1 or 2, wherein the unique identifier is embedded in a barcode.

Clause 4: The method of any of clauses 1-3, wherein the unique identifier deactivates in response to the user associated with the unique identifier using the unique identifier to place an order request.

Clause 5: The method of any of clauses 1-4, further comprising: in response to generating each unique identifier, communicating, with at least one processor, each respective unique identifier to a computing device associated with an associated user of the plurality of users.

Clause 6: The method of any of clauses 1-5, wherein the computing device comprises at least one of the following: a smartphone, a laptop, a tablet computer, a desktop computer, an in-store kiosk, or any combination thereof.

Clause 7: The method of any of clauses 1-6, wherein the request includes limit data comprising a maximum total transaction value and/or a maximum value per order request.

Clause 8: The method of any of clauses 1-7, wherein the time period expires after a predetermined duration or at a predetermined time.

Clause 9: The method of any of clauses 1-8, wherein the time period expires in response to receiving an order request from each user of the plurality of users.

Clause 10: The method of any of clauses 1-9, wherein the time period expires in response to not receiving a further order request for a predetermined time period.

Clause 11: A system for combining a plurality of separate orders into a single transaction, comprising at least one server computer including at least one processor, the at least one server computer programmed or configured to: receive a request from a first user device identifying a plurality of users; in response to receiving the request, generate a unique identifier for each user of the plurality of users; receive a plurality of order requests within a time period from a plurality of computing devices associated with at least a subset of users of the plurality of users, each order request of the plurality of order requests identifying the unique identifier for a respective user; determine that the time period has expired; and in response to determining that the time period has expired, generate an authorization request for a total transaction value of the plurality of order requests.

Clause 12: The system of clause 11, wherein the unique identifier comprises an identifier embedded in a link.

Clause 13: The system of clause 11 or 12, wherein the unique identifier is embedded in a barcode.

Clause 14: The system of any of clauses 11-13, wherein the unique identifier deactivates in response to the user associated with the unique identifier using the unique identifier to place an order request.

Clause 15: The system of any of clauses 11-14, wherein the at least one server computer is further programmed or configured to: in response to generating each unique identifier, communicate each respective unique identifier to a computing device associated with an associated user of the plurality of users.

Clause 16: The system of any of clauses 11-15, wherein the computing device comprises at least one of the following: a srnartphone, a laptop, a tablet computer, a desktop computer, an in-store kiosk, or any combination thereof.

Clause 17: The system of any of clauses 11-16, wherein the request includes limit data comprising a maximum total transaction value and/or a maximum value per order request.

Clause 18: The system of any of clauses 11-17, wherein the time period expires after a predetermined duration or at a predetermined time.

Clause 19: The system of any of clauses 11-18, wherein the time period expires in response to receiving an order request from each user of the plurality of users.

Clause 20: A computer program product for combining a plurality of separate orders into a single transaction comprising at least one non-transitory computer-readable medium including program instructions that, when executed by at least one processor, cause the at least one processor to: receive a request from a first user device identifying a plurality of users; in response to receiving the request, generate a unique identifier for each user of the plurality of users; receive a plurality of order requests within a time period from a plurality of computing devices associated with at least a subset of users of the plurality of users, each order request of the plurality of order requests identifying the unique identifier for a respective user; determine that the time period has expired; and in response to determining that the time period has expired, generate an authorization request for a total transaction value of the plurality of order requests.

These and other features and characteristics of the present invention, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and the claims, the singular form of “a,” “an,” and “the” include plural referents unless the context clearly dictates otherwise.

### BRIEF DESCRIPTION OF THE DRAWINGS

Additional advantages and details of the invention are explained in greater detail below with reference to the exemplary embodiments that are illustrated in the accompanying schematic figures, in which:

FIG. 1 is a schematic view of one non-limiting embodiment or aspect of a system for combining a plurality of separate orders into a single transaction;

FIG. 2 is a schematic view of one non-limiting embodiment or aspect of a system for processing a transaction that includes a plurality of separate orders that have been combined into a single order;

FIG. 3A is a schematic view of one non-limiting embodiment or aspect of a system in which an order request processor generates and communicates a unique identifier for each of a plurality of users;

FIG. 3B is a schematic view of one non-limiting embodiment or aspect of a system in which a plurality of users communicate order requests to an order request processor;

FIG. 4 is schematic view of one non-limiting embodiment or aspect of a group request;

FIG. 5 is schematic view of one non-limiting embodiment or aspect of an order request message;

FIG. 6 is a step diagram of one non-limiting embodiment or aspect of a method for combining a plurality of separate orders into a single transaction; and

FIG. 7 is a process flow diagram of one non-limiting embodiment or aspect of a method for combining a plurality of separate orders into a single transaction.

### DESCRIPTION OF THE INVENTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the invention as it is oriented in the drawing figures. However, it is to be understood that the invention may assume various alternative variations and step sequences, except where expressly specified to the contrary. It is also to be understood that the specific devices and processes illustrated in the attached drawings, and described in the following specification, are simply exemplary embodiments or aspects of the invention. Hence, specific dimensions and other physical characteristics related to the embodiments or aspects disclosed herein are not to be considered as limiting.

As used herein, the terms “communication” and “communicate” may refer to the reception, receipt, transmission, transfer, provision, and/or the like, of information (e.g., data, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and communicates the processed information to the second unit. In some non-limiting embodiments, a message may refer to a network packet (e.g., a data packet, and/or the like) that includes data. It will be appreciated that numerous other arrangements are possible.

As used herein, the term “transaction service provider” may refer to an entity that receives transaction authorization requests from merchants or other entities and provides guarantees of payment, in some cases through an agreement between the transaction service provider and an issuer institution. For example, a transaction service provider may include a payment network such as Visa® or any other entity that processes transactions. The term “transaction processing system” may refer to one or more computer systems operated by or on behalf of a transaction service provider, such as a transaction processing server executing one or more software applications. A transaction processing system may include one or more processors and, in some non-limiting embodiments, may be operated by or on behalf of a transaction service provider.

As used herein, the term “issuer institution” or “issuer” may refer to one or more entities, such as a bank, that provide accounts to customers for conducting transactions (e.g., payment transactions), such as initiating credit and/or debit payments. For example, an issuer institution may provide an account identifier, such as a personal account number (PAN), to a customer that uniquely identifies one or more accounts associated with that customer. The account identifier may be embodied on a portable financial device, such as a physical financial instrument, e.g., a payment card, and/or may be electronic and used for electronic payments. The term “issuer system” refers to one or more computer systems operated by or on behalf of an issuer institution, such as a server computer executing one or more software applications. For example, an issuer system may include one or more authorization servers for authorizing a transaction.

As used herein, the term “merchant” may refer to an individual or entity that provides goods and/or services, or access to goods and/or services, to customers based on a transaction, such as a payment transaction. The term “merchant” or “merchant system” may also refer to one or more computer systems operated by or on behalf of a merchant, such as a server computer executing one or more software applications. A “point-of-sale (POS) system,” as used herein, may refer to one or more computers and/or peripheral devices used by a merchant to engage in payment transactions with customers, including one or more card readers, near-field communication (NFC) receivers, RFID receivers, and/or other contactless transceivers or receivers, contact-based receivers, payment terminals, computers, servers, input devices, and/or other like devices that can be used to initiate a payment transaction.

As used herein, the term “portable financial device” may refer to a payment card (e.g., a credit or debit card), a gift card, a smartcard, smart media, a payroll card, a healthcare card, a wrist band, a machine-readable medium containing account information, a keychain device or fob, an RFID transponder, a retailer discount or loyalty card, a cellular phone, an electronic wallet mobile application, a personal digital assistant (PDA), a pager, a security card, a computer, an access card, a wireless terminal, a transponder, and/or the like. In some non-limiting embodiments, the portable financial device may include volatile or non-volatile memory to store information (e.g., an account identifier, a name of the account holder, and/or the like).

As used herein, the term “computing device” may refer to one or more electronic devices that are configured to directly or indirectly communicate with or over one or more networks. The computing device may be a mobile device. As an example, a mobile device may include a cellular phone (e.g., a smartphone or standard cellular phone), a portable computer (e.g., laptop computer or tablet computer), a wearable device (e.g., watches, glasses, lenses, clothing, and/or the like), a personal digital assistant (PDA), and/or other like devices. In other non-limiting embodiments, the computing device may be a desktop computer or other non-mobile computer, such as an in-store kiosk. Furthermore, the term “computer” may refer to any computing device that includes the necessary components to receive, process, and output data, and normally includes a display, a processor, a memory, an input device, and a network interface. An “application” or “application program interface” (API) refers to computer code or other data sorted on a computer-readable medium that may be executed by a processor to facilitate the interaction between software components, such as a client-side front-end and/or server-side back-end for receiving data from the client. An “interface” refers to a generated display, such as one or more graphical user interfaces (GUIs) with which a user may interact, either directly or indirectly (e.g., through a keyboard, mouse, etc.).

As used herein, the term “server” may refer to or include one or more processors or computers, storage devices, or similar computer arrangements that are operated by or facilitate communication and processing for multiple parties in a network environment, such as the Internet, although it will be appreciated that communication may be facilitated over one or more public or private network environments and that various other arrangements are possible. Further, multiple computers, e.g., servers, or other computerized devices, e.g., point-of-sale devices, directly or indirectly communicating in the network environment may constitute a “system,” such as a merchant's point-of-sale system. Reference to “a server” or “a processor,” as used herein, may refer to a previously-recited server and/or processor that is recited as performing a previous step or function, a different server and/or processor, and/or a combination of servers and/or processors. For example, as used in the specification and the claims, a first server and/or a first processor that is recited as performing a first step or function may refer to the same or different server and/or a processor recited as performing a second step or function.

Non-limiting embodiments or aspects of the present invention are directed to a method, system, and computer program product for combining a plurality of separate orders into a single transaction. Non-limiting embodiments allow for a group organizer (e.g., a payer user) to submit a request to an order request processor, which automatically collects and combines order requests from the various users in the group. The order request processor may be specifically programmed to automatically combine customized order requests to generate a single authorization request, which may be processed as a single payment transaction. Non-limiting embodiments eliminate the cumbersome manual processes required by the group organizer in existing systems to manually collect and combine the orders of the group of users by using a new order request processor programmed to automatically combine multiple order requests. Non-limiting embodiments allow the users of the group to have the flexibility to customize their individual order requests based on their individual tastes, and to use their own computing devices to do so, as the system may allow each individual user to fill out an order request as if it were an individual order. Non-limiting embodiments allow the group user to maintain control of important aspects of the order, such as who is a member of the group, how much is permitted per order or for the total transaction, or when the deadline by which order must be submitted is. Non-limiting embodiments can also track who has already ordered in the group and prevent duplicate ordering. Thus, the non-limiting embodiments improve the efficiency of placing group orders, while maintaining the flexibility available to the individual users and the group organizer.

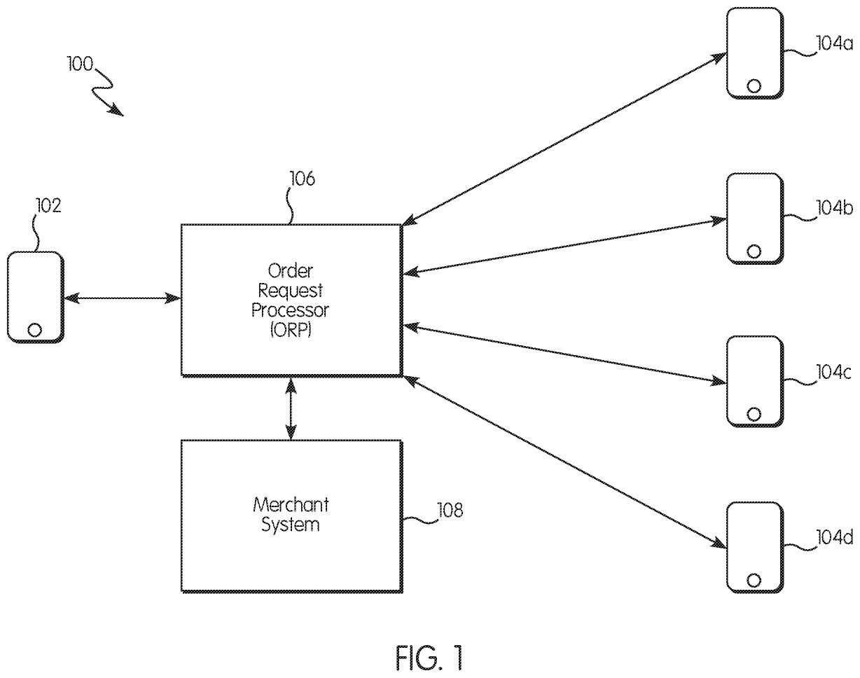

Referring to FIG. 1, a system 100 for combining a plurality of separate orders into a single transaction is shown. The system 100 may include a group organizer device 102 (used interchangeably with payer device 102), which may be a computing device. Non-limiting examples of the group organizer device 102 may include at least one of the following: a smartphone, a laptop, a tablet computer, a desktop computer, an in-store kiosk, or any combination thereof. The group organizer device 102 may be a computing device operated by or on behalf of the group organizer, who may be the individual initiating the group order. The group organizer may be the payer of the group order (e.g., the individual who is the account owner of the portable financial device being used to initiate processing of the single payment transaction for the group order). The system 100 may also include a plurality of devices 104a-104d associated with group users of the group order. Non-limiting examples of the devices 104a-104d associated with the group users may include at least one of the following: a srnartphone, a laptop, a tablet computer, a desktop computer, an in-store kiosk, or any combination thereof. The group users may be individuals included in the group placing the order being combined into a single transaction by the system 100.

The system 100 may also include an order request processor 106 (ORP), which may communicate with the group organizer device 102 and the devices 104a-104d associated with the group users. The ORP 106 may be operated by or on behalf of a merchant, a transaction service provider, an issuer, or other entity involved in processing transactions. The system 100 may also include a merchant system 108, such as a merchant point-of-sale system, which may be operated by or on behalf of a merchant. The merchant system 108 may communicate with the ORP 108 and may be configured to process transactions, such as the combined group order transactions described herein. The merchant may be any merchant that offers goods and/or services in exchange for a monetary value and, in some examples, may be a take-out or delivery restaurant, coffee shop, ice cream parlor) or any other type of merchant.

With continued reference to FIG. 1, the ORP 106 may be configured to combine a plurality of separate individual orders from the group users into a single transaction, such that the group order can be processed as a single transaction. The group organizer may initiate the group order by submitting a group request using the group organizer device 102. The group organizer device 102 may communicate the group request to the ORP 106 to initiate the group order. The group request may specify the group users included in the group order and user data allowing the ORP 106 to communicate with each group user (e.g., cell phone number, email address, account ID, user name, and the like). The group request may also specify a time period associated with the group order.

With continued reference to FIG. 1, the ORP 106 may receive the group request from the group organizer device 102 and, in response, generate a unique identifier for each group user. The unique identifier may be any type of identifier unique to an individual group user of the group. The unique identifier generated by the ORP 106 may include an identifier embedded in a link. The link may open a web browser or mobile application, such that the individual group user may click the link to be identified as that particular group user and to place an order request with that group. The unique identifier generated by the ORP 106 may be embedded in a barcode, or other machine-readable indicia, such as a OR code unique to a group user of the group. The unique identifier generated by the ORP may be an alphanumeric code or string, as examples, unique to a group user of the group. In some examples, the unique identifier may be an identifier associated with the device 104a-104d (e.g., a device identifier).

The ORP 106 may also generate an order identifier associated with the group order. The order identifier may be any of the above-described types of unique identifiers and may be used to identify a specific group order or to identify a group user as being a member of the group. The ORP 106 may communicate the unique identifier of the group user and/or the group identifier to each device 104a-104d associated with the group users, such that each group user receives his/her unique identifier and/or the group identifier generated by the ORP 106.

In response to receiving the unique identifier, the user may access a graphical user interface (GUI) on the device 104a-104d to place an order request. For example, the user may click the link or scan the barcode receive on each device 104a-104d, which automatically opens the GUI (e.g., website or mobile application) to allow the user to place an order request.

With continued reference to FIG. 1, each group user, in response to receiving the unique identifier and/or the group identifier, may place an order request. Each group user may, using the device 104a-104d associated with the group user, determine which items that group user wishes to include in the group order. In this way, the group user may customize his/her portion of the group order based on his/her individual tastes. The group user may select items to include on the order using a website and/or application operated by or on behalf of the merchant, such as an interactive menu posted to the website or application of the merchant. The group user may select a single item or multiple items and may customize those items as desired (e.g., quality, size, design, flavor, toppings, or other configurable options). Once the group user has selected the desired items, the group user may communicate the customized order request to the ORP 106 using the device 104a-104d associated with the group user. The order request may include the unique identifier associated with the group user or the group identifier to identify the order request as being associated with a particular group user of a particular group. The ORP 106 may receive the various individual customized orders from the group users of the group order.

With continued reference to FIG. 1, the ORP 106 may determine that the time period associated with the group order has expired. In response to determining that the time period has expired, the ORP 106 may generate an authorization request for the group order. The authorization request may include a total transaction value, which represents a sum of the amounts of each individual order request. The total transaction value may include additional required fees, such as taxes, a tip, a grouping fee for combining the order requests, or the like. The authorization request may specify the total transaction value and a combined listing of the items requested in the various order requests of the group. In this way, the authorization request may be a single authorization request to process and fulfill the combined order requests from the various group users in the group order. The ORP 106 may communicate the authorization request to the merchant system 108 for processing of the financial transaction and for order fulfillment by the merchant. It will be appreciated that in some instances, the ORP 106 and the merchant system 108 may both be operated by or on behalf of the merchant and, in some examples, may be the same system/processor.

With continued reference to FIG. 1, in some non-limiting embodiments, the ORP 106 may communicate the authorization request to the group organizer device 102 prior to the authorization request being communicated to the merchant system 108. The group organizer may review the group's order included in the authorization request and communicate final approval for the group order or may cancel or modify the group order.

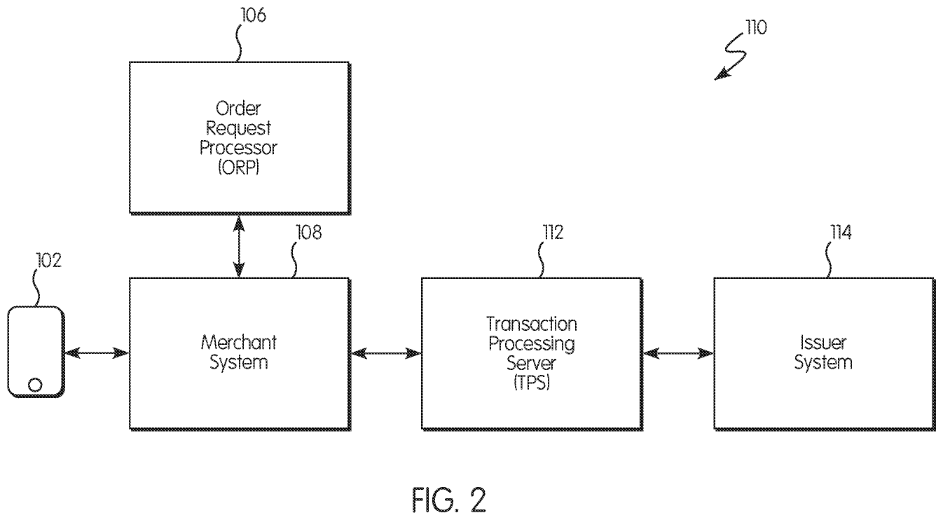

Referring to FIG. 2, a system 110 for processing a group transaction based on the authorization request received from the ORP 106 is shown. Once the merchant system 108 receives the authorization request from the ORP 106, the merchant system 108 may communicate the authorization request to a transaction processing system (TPS) 112. The merchant system 108 may also communicate with the group organizer device 102 to notify the group organizer that the group order has been closed and has been communicated for processing. This notification may also notify the group organizer device 102 as to when the order is available for pick-up or will be delivered. The merchant system 108 may also request payment information (e.g., portable financial device information) at this time from the group organizer device 102, if not already received. The TPS 112 may be operated by or on behalf of a transaction service provider. The TPS 112 to which the merchant system 108 communicates the authorization request may be operated by or on behalf of the transaction service provider associated with the portable financial device used to initiate the group order. The portable financial device, including the account identifiers thereof (e.g., PAN number, token expiration date, CVV code, or the like), may be specified in the initial group request or may be subsequently received by the merchant system 108 and/or the ORP 106.

With continued reference to FIG. 2, the TPS 112 may communicate the authorization request to the issuer system 114 operated by or on behalf of the issuer of the portable financial device used to initiate the group order. In response to receiving the authorization request, the issuer system 114 may determine whether to approve or decline the group transaction and may communicate that authorization decision to the TPS 112. The TPS 112 may communicate the authorization decision to the merchant system 108. The merchant system 108 may communicate the authorization decision to the group organizer device 102.

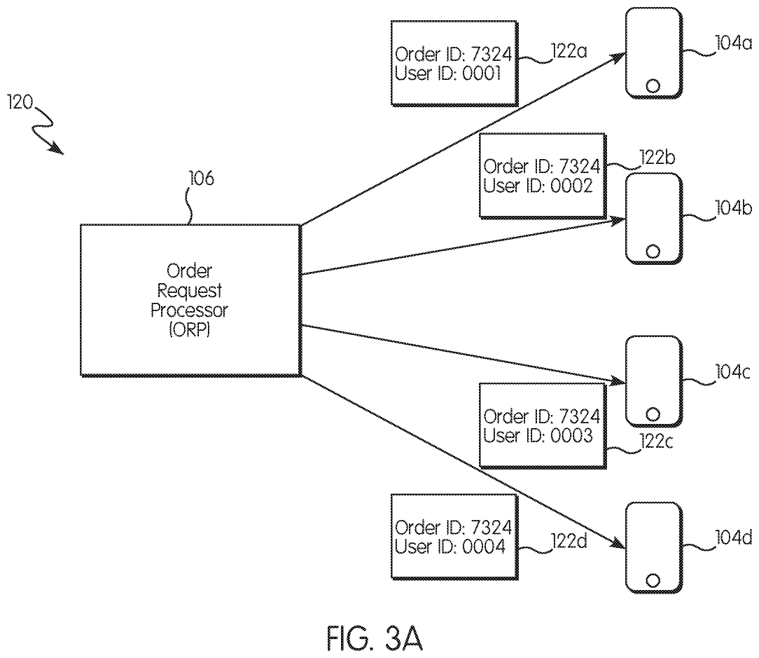

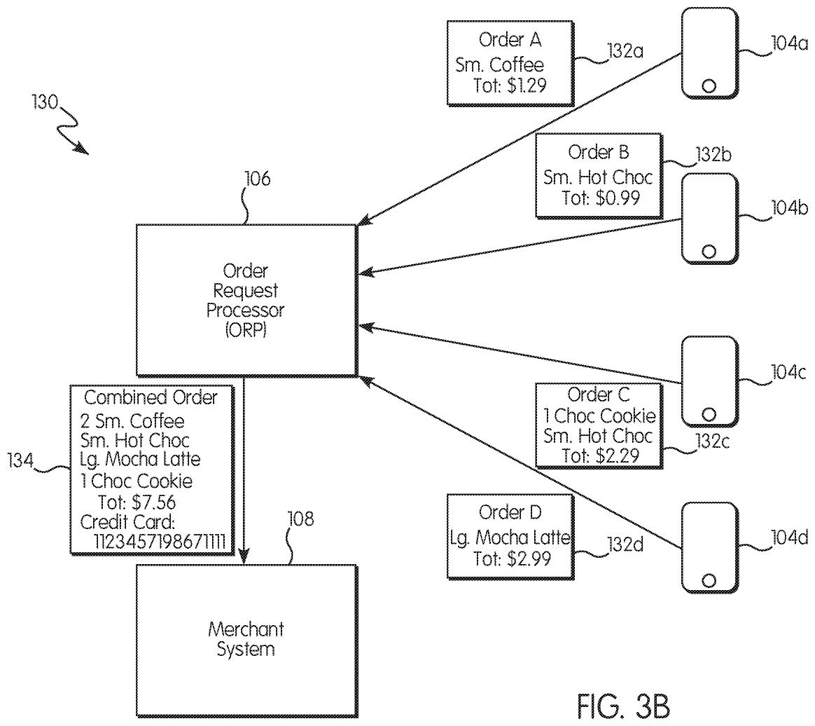

Referring to FIG. 3A, a system 120 in which the ORP 106 generates and communicates a unique identifier and/or a group identifier to each device 104a-104d associated with the group users is shown according to a non-limiting embodiment. As can be seen in FIG. 3A, the ORP 106 may communicate a message 122a-122d to each device 104a-104d, respectively, associated with the group users. In this non-limiting example, each message 122a-122d includes the same group identifier (e.g., “Order ID” in FIG. 3A, which is “7324”). In this non-limiting example, each message 122a-122d includes the different unique identifier (e.g., “User ID” in FIG. 3A) for each group user. For example, the User ID for “user a” (associated with user device 104a) is shown as “0001”, which is different from the User ID's of users b-d (shown as “0002”, “0003”, and “0004”, respectively). The group identifier and unique identifiers used in this example are numerical codes; however, any of the previously described unique identifiers are contemplated for this invention.

With continued reference to FIG. 3A, the unique identifier and/or the group identifier may be communicated from the ORP 106 to each device 104a-104d associated with the group users using any suitable communication message. In some examples, the unique identifier and/or the group identifier are communicated via an email, a text message, a push notification, or the like. In some examples, the unique identifier and/or the group identifier are communicated using an alert pushed to the group user via the merchant application, which is downloaded on the device 104a-104d associated with the group users.

Referring to FIG. 3B, a system 130 in which the devices 104a-104d associated with the group users communicate order requests to the ORP 106 is shown. As can be seen in FIG. 3B, the ORP 106 may receive an order request message 132a-132d from each device 104a-104d associated with the group users. The order request message 132a-132d may include a list of the items the group user wishes to order from the menu of items available from the merchant. The order request message 132a-132d may include further information as well. For example, the order request message 132a-132d may include a total order amount, which reports the price associated with the received order request. The order request message 132a-132d may include any comments from the group user regarding preparation of the items in the order to allow for further order customization (e.g., “leave room for cream and sugar in the coffee”). The order request message 132a-132d may include the unique identifier and/or the group identifier received from the ORP 106 to associate the group user with the particular group (using the group identifier) or to identify the specific group user submitting the order request message (using the unique identifier).

With continued reference to FIG. 3B, in response to communicating the order request message using the device 104a-104d associated with the group user, the unique identifier associated with that group user may expire (e.g., be deactivated) to prevent another individual from placing an order request using the already-used unique identifier. This feature may prevent another user from placing an order request using the same unique identifier, but may still allow the user submitting the original order request to edit or update his/her initial order request until expiration of the time period.

With continued reference to FIG. 3B, in response to receiving order request messages from each device 104a-104d associated with the group users, the ORP 106 may combine the order requests associated with the same group order to form a combined group order in an authorization request 134. The combined group order may list all of the items ordered by the various group users. The authorization request 134 may include the combined group order. The authorization request 134 may include the unique identifiers and/or the group identifiers. The authorization request 134 may also include a total amount of the group order, which may be the sum of the amounts of each individual order request message received by the ORP 106 associated with the group order. Additionally, the authorization request may also include an account identifier, such as a PAN, token, and/or other payment information, associated with the group order. Thus, the authorization request 134 may include any information required for the merchant to fulfill the group order and any information required to process the single payment transaction for the group order. The ORP 106 may communicate the authorization request 134 to the merchant system 108 for processing of the group order (including the items ordered and the payment transaction).

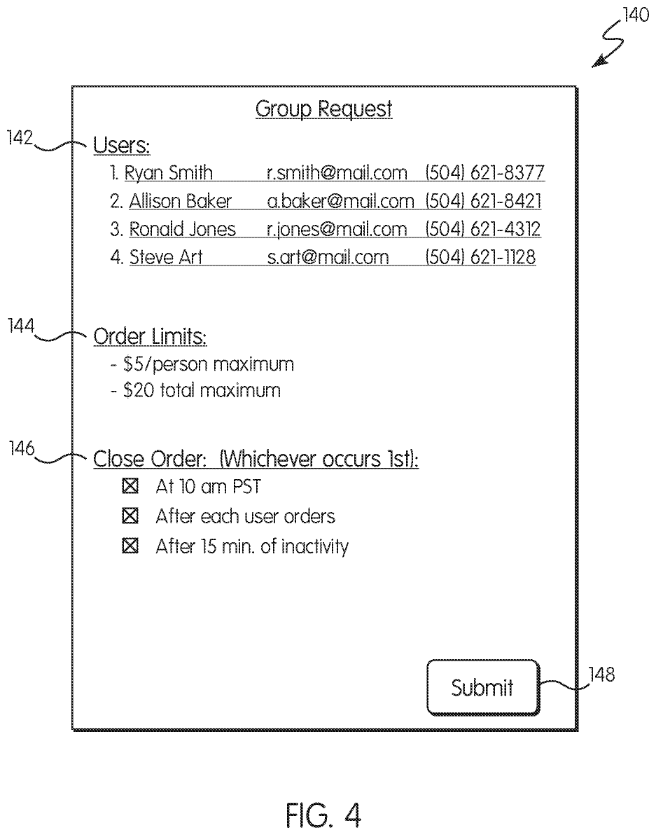

Referring to FIG. 4, a non-limiting embodiment of a group request 140 sent by or on behalf of a device of a group organizer is shown. As previously described, the group request 140 may be generated by the group organizer using the group organizer device 102. The group request 140 may define a group user list 142, which defines the group users to be included in the group order. The group user list 142 may include the names of the group users to be included. The group user list 142 may also include contact information of the group users to allow the ORP 106 to communicate the generated unique identifier and/or group identifier. The contact information may include an email address or phone number, for example. Alternatively or additionally, the group user list may include a user name (not shown) associated with each group user. For example, the user name may be a user name used by each group user as a member of a program (e.g., rewards program) of the merchant or as a login to an account issued by the merchant. The user name may be the user name associated with the group user who uses the merchant's application. The user name may also be a user name or handle associated with a social media profile of the group user, such that the ORP 106 can communicate the generated unique identifier and/or group identifier via a message to the group user over the social media platform. Any other information required to identify group users and contact group users may be included in the group user list 142 of the group request 140.

With continued reference to FIG. 4, the group request 140 may further include an order limits list 144. The group organizer may specify order limits in the order limits list 144 to exercise further control over the group order. The order limits may include a limit on each order request of the group users, such that each group user is allotted only a certain amount of money (e.g., each user may spend a maximum of $5). The group user exceeding the individual maximum may be notified that his/her order request exceeded the individual limit and may be allowed to adjust the order accordingly. The order limits may include a limit on the order total itself, such that the group organizer can cap the amount of the total group order (e.g., the order total may not exceed $20). The group order may not be processed if the order total exceeds the maximum order amount or may require an order request putting the group order over the limit be modified. As another non-limiting example, the user may limit the types of items that are available in the group order (e.g., imposing a restriction on the purchase of alcoholic beverages in the group order). As another non-limiting example, the group organizer may limit the number of individuals in the group order. For example, the group organizer may specify that the first 5 group users submitting order requests of 10 group users specified in the group user list 142 may form the group order.

With continued reference to FIG. 4, the group organizer may specify a time period limit 146 associated with the group order. The ORP 106 may determine whether the time period has expired based on the time period limit 146. In response to determining that the time period has expired, the ORP 106 may generate the authorization request 134 including the total transaction value of the plurality of order requests in the group and communicate that authorization request 134 to the merchant system 108. The time period limit 146 may include a predetermined duration after which the time period expires (e.g. the time period expires 1 hour after the group request is submitted). The time period limit 146 may include a predetermined standard time at which the time period expires (e.g., the time period expires at 10 AM PST). The time period limit 146 may specify that the time period automatically expires in response to each group user in the group placing their order request (such that there are no outstanding orders). The time period limit 146 may specify that the time period automatically expires after the ORP 106 does not receive a further order request for a predetermined time period (e.g., after 15 minutes of inactivity without receiving a further order request). Group users who have previously submitted an order request may edit or update their order request until the time period has expired. Multiple time period limits 146 may be specified, and the first time period limit 146 satisfied may be used as the time period associated with the group order.

In some non-limiting embodiments, the group order 140 may include a requested pick-up time for the group order or location information (e.g, an address) and time for delivery of the group order.

With continued reference to FIG. 4, after completing the group request 140, the group organizer may select a submit button 148 to initiate the group order, which allows the group organizer to communicate the group request to the ORP 106, which subsequently generates the unique identifiers for each of the group users.

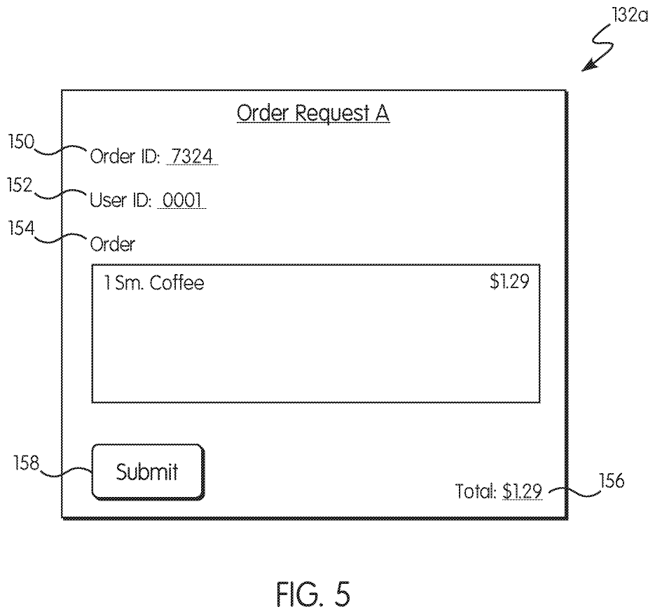

Referring to FIG. 5, a non-limiting embodiment of an order request message 132a sent by or on behalf of a device of a group user of the group is shown. The order request message 132a may specify the group identifier 150 associated with the group order. The order request message may specify the unique identifier 152 associated with the specific group user. The order message 132a may specify the order 154 of the group user, such as the items ordered, any custom instructions, and a subtotal for each item. The order request message 132a may include a group request total 156, which calculates the total amount of the order request for the group user (sum of items selected by the group user). The order request message 132a may include a submit button 158 to allow the group user to communicate the order request message 132a to the ORP 106. Any other information required to specify the order of the group user may be included in the order request message 132a.

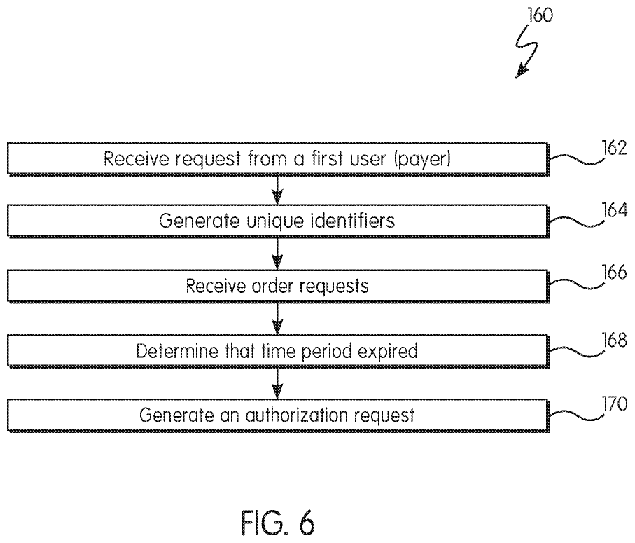

Referring to FIG. 6, a method 160 for combining a plurality of separate orders into a single transaction is shown. At a first step 162, the ORP 106 may receive an order request from a first user device (group organizer device 102) (e.g., of the payer and/or group organizer) identifying a plurality of group users. At a second step 164, the ORP 106 may, in response to receiving the request, generate a unique identifier for each user of the plurality of users and/or a group identifier. At a third step 166, the ORP 106 may receive a plurality of order requests within a time period from a plurality of computing devices associated with at least a subset of users of the plurality of users, each order request of the plurality of order requests identifying the unique identifier for a respective user. At a fourth step 168, the ORP 106 may determine that the time period has expired. At a fifth step 170, the ORP 106 may, in response to determining that the time period has expired, generate an authorization request for a total transaction value of the plurality of order requests.

In a further, non-limiting embodiment or aspect, a computer program product for combining a plurality of separate orders into a single transaction includes at least one non-transitory computer readable medium including program instructions that, when executed by at least one processor, cause the at least one processor to execute any of the methods described herein. The at least one processor may include the order request processor 106.

The following example is provided to illustrate an embodiment of the system, method, and computer program product for combining a plurality of separate orders into a single transaction, and is not meant to be limiting.

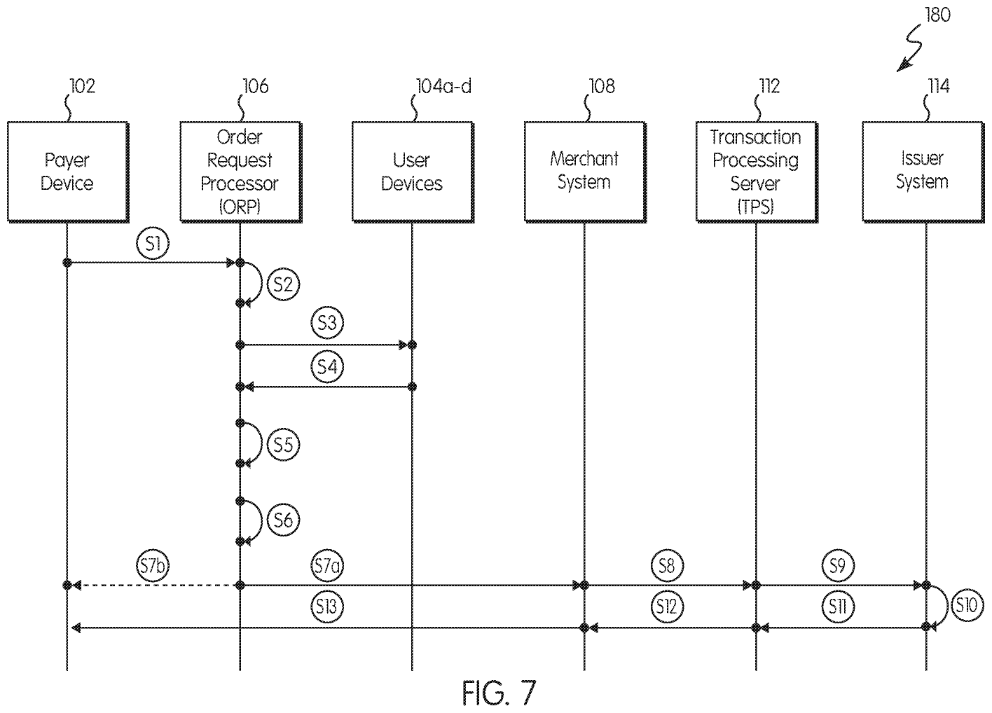

Referring to FIG. 7, a method 180 for combining a plurality of separate orders into a single transaction is shown. In this example, Albert is the team lead of four employees (Ryan, Allison, Ronald, and Steve) at Acme Inc., and Albert wants to treat his team to coffee at The Coffee Shop the morning after an important late night project for the company. The Coffee Shop accepts walk-in orders or remote orders that can be picked up or delivered after the order has been placed remotely. In this Example, Albert is the group organizer, and Ryan, Allison, Ronald, and Steve are the group users forming the group. Albert has a smartphone (the group organizer device/payer device 102), as do Ryan, Allison, Ronald, and Steve (the devices 104a-104d associated with the group users). Albert wishes to have each of his team members order the items they want so he does not need to manually collet each individual's order. Albert is both the group organizer and the payer in this example. Albert wishes to pay for the group order using his corporate credit card, issued by First Issuer Bank (an issuer bank) and associated with First TSP (a transaction service provider).

Referring back to FIG. 4 and with continued reference to FIG. 7, at a first step S1, Albert communicates the group request 140 from FIG. 4 from his payer device 102 (his smartphone) to the ORP 106, which is operated by or on behalf of The Coffee Shop. The group request 140 includes the names of each of Albert's team members (Ryan, Allison, Ronald, and Steve), who are the group users. The contact information (email address and telephone number in this case) are specified for each team member. The group request 140 limits each group user to $5 and caps the entire order at $20 using order limits. The group request 140 specifies several time period limits including closing the group order at 10 AM PST, after each user orders, or after 15 minutes of inactivity, whichever occurs first.

With continued reference to FIG. 7, at a second step S2, the ORP 106, in response to receiving the group request 140, generates a unique identifier for each of Ryan, Allison, Ronald, and Steve and generates a group identifier for the group.

Referring back to FIG. 3A and with continued reference to FIG. 7, at a third step S3, the ORP 106 communicates a message 122a-122d to the devices 104a-104d associated with the group users that includes the unique identifier and/or the group identifier. In this case, the group identifier is “7324” and the unique identifiers are “0001”, “0002”, “0003”, and “0004”, respectively.

Referring back to FIG. 3B and with continued reference to FIG. 7, at a fourth step S4, each group user determines their customized order and communicates an order request message 132a-132d containing that order to the ORP 106. At a fifth step S5, the ORP 106 determines that the time period for the group order has expired based on having receive an order from each of Ryan, Allison, Ronald, and Steve within 5 minutes of the order request 140 being submitted by Albert. At a sixth step S6, in response to determining that the time period has expired, the ORP 106 generates an authorization request 134 containing the combined order of the group users, the total amount of the group order, and Albert's credit card information. At a seventh step S7a, the ORP communicates the authorization request 134 to the merchant system 108 of The Coffee Shop to process the order and the single payment transaction. The ORP 102 also communicates with Albert's payer device 102 at step S7b to notify Albert that the order is submitted and when the order can be ready for pick-up at The Coffee Shop or when the order can be delivered to Albert's location. Albert or another team member may pick up or receive the group order.

With continued reference to FIG. 7, at an eighth step S8, the merchant system 108 communicates the authorization request 134 to the TPS 112 of First TSP. At a ninth step S9, the TPS communicates the authorization request 134 to the issuer system 114 of First Issuer Bank. At a tenth step S10, the issuer system 114 determines an authorization decision, which is to approve the payment transaction for the group order. At an eleventh step S11, the issuer system 114 communicates the authorization decision (approval) to the TPS 112. At a twelfth step S12, the TPS communicates the authorization decision to the merchant system 108. At a thirteenth step S13, the merchant system 108 communicates with Albert's payer device 102 to notify Albert that the payment transaction has been successfully processed.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

The invention claimed is:

1. A computer-implemented method for combining a plurality of separate orders into a single transaction comprising:
receiving, with at least one processor, a request from a first user device identifying a plurality of users;
in response to receiving the request, generating, with at least one processor, a unique identifier for each user of the plurality of users;
receiving, with at least one processor, a plurality of order requests within a time period from a plurality of computing devices associated with at least a subset of users of the plurality of users, each order request of the plurality of order requests identifying the unique identifier for a respective user;
determining, with at least one processor, that the time period has expired; and
in response to determining that the time period has expired, generating, with at least one processor, an authorization request for a total transaction value of the plurality of order requests.

2. The method of claim 1, wherein the unique identifier comprises an identifier embedded in link.

3. The method of claim 1, wherein the unique identifier is embedded in a barcode.

4. The method of claim 1, wherein the unique identifier deactivates in response to the user associated with the unique identifier using the unique identifier to place an order request.

5. The method of claim 1, further comprising:
in response to generating each unique identifier, communicating, with at least one processor, each respective unique identifier to a computing device associated with an associated user of the plurality of users.

6. The method of claim 1, wherein the computing device comprises at least one of the following: a smartphone, a laptop, a tablet computer, a desktop computer, an in-store kiosk, or any combination thereof.

7. The method of claim 1, wherein the request includes limit data comprising a maximum total transaction value and/or a maximum value per order request.

8. The method of claim 1, wherein the time period expires after a predetermined duration or at a predetermined time.

9. The method of claim 1, wherein the time period expires in response to receiving an order request from each user of the plurality of users.

10. The method of claim 1, wherein the time period expires in response to not receiving a further order request for a predetermined time period.

11. A system for combining a plurality of separate orders into a single transaction, comprising at least one server computer including at least one processor, the at least one server computer programmed or configured to:
receive a request from a first user device identifying a plurality of users;
in response to receiving the request, generate a unique identifier for each user of the plurality of users;
receive a plurality of order requests within a time period from a plurality of computing devices associated with at least a subset of users of the plurality of users, each order request of the plurality of order requests identifying the unique identifier for a respective user;
determine that the time period has expired; and
in response to determining that the time period has expired, generate an authorization request for a total transaction value of the plurality of order requests.

12. The system of claim 11, wherein the unique identifier comprises an identifier embedded in link.

13. The system of claim 11, wherein the unique identifier is embedded in a barcode.

14. The system of claim 11, wherein the unique identifier deactivates in response to the user associated with the unique identifier using the unique identifier to place an order request.

15. The system of claim 11, wherein the at least one server computer is further programmed or configured to:
in response to generating each unique identifier, communicate each respective unique identifier to a computing device associated with an associated user of the plurality of users.

16. The system of claim 11, wherein the computing device comprises at least one of the following: a smartphone, a laptop, a tablet computer, a desktop computer, an in-store kiosk, or any combination thereof.

17. The system of claim 11, wherein the request includes limit data comprising a maximum total transaction value and/or a maximum value per order request.

18. The system of claim 11, wherein the time period expires after a predetermined duration or at a predetermined time.

19. The system of claim 11, wherein the time period expires in response to receiving an order request from each user of the plurality of users.

20. A computer program product for combining a plurality of separate orders into a single transaction comprising at least one non-transitory computer-readable medium including program instructions that, when executed by at least one processor, cause the at least one processor to:
receive a request from a first user device identifying a plurality of users;
in response to receiving the request, generate a unique identifier for each user of the plurality of users;
receive a plurality of order requests within a time period from a plurality of computing devices associated with at least a subset of users of the plurality of users, each order request of the plurality of order requests identifying the unique identifier for a respective user;
determine that the time period has expired; and
in response to determining that the time period has expired, generate an authorization request for a total transaction value of the plurality of order requests.
